(19) United States
(12) Patent Application Publication
(10) Pub. No.: US 2024/0158263 A1
(43) Pub. Date: May 16, 2024

(54) DESALINATION ARCHITECTURE

(71) Applicant: Georgia Tech Research Corporation, Atlanta, GA (US)

(72) Inventor: Joshua D. Brooks, Atlanta, GA (US)

(21) Appl. No.: 18/507,303

(22) Filed: Nov. 13, 2023

Related U.S. Application Data
(60) Provisional application No. 63/383,594, filed on Nov. 14, 2022.

(51) Int. Cl. C02F 1/00

(52) U.S. Cl. CPC C02F 1/008; C02F 2103/08; C02F 2201/009

(57) ABSTRACT

A method of selecting a desalination architecture includes a) constructing a desalting subsystem model comprising a superstructure representation configured to evaluate a plurality of desalting subsystems in response to desalting subsystem input parameters; b) constructing an energy subsystem model configured to evaluate a plurality of energy subsystems in response to energy subsystem input parameters; c) selecting an objective function configured to minimize one or more system attributes for a desalination architecture; d) while evaluating one of the plurality of desalting subsystems with the plurality of desalting subsystem input parameters using the desalting subsystem model, determining an optimal one of the plurality of energy subsystems using the energy subsystem model based on the energy requirements of the evaluated one of the plurality of desalting subsystems and the energy subset input parameters; e) evaluating a desalination architecture comprising the evaluated one of the plurality of desalting subsystems and the optimal one of the plurality of energy subsystems; f) if the objective function of the desalination architecture comprising the evaluated one of the plurality of desalting subsystems and the optimal one of the plurality of energy subsystems is not minimized, repeating steps d) and e) with a different one of the plurality of desalting subsystems; and g) when the objective function of the desalination architecture is minimized, selecting the desalination architecture wherein the desalination architecture comprises one of the plurality of desalting subsystems and one of the plurality of energy subsystems.

### RELATED APPLICATIONS

This application claims priority under 35 U.S.C. § 119(e) to U.S. Provisional Application No. 63/383,594, filed Nov. 14, 2022, the entirety of which is hereby incorporated by reference.

### FIELD OF THE INVENTION

The present invention relates to desalination systems and methods, and in particular, to desalination systems and methods for removing salt from seawater, brackish water, or other wastewater streams for the production of potable or agriculture grade water.

### BACKGROUND

Desalination systems may be used to expand water supplies while remaining relatively insensitive to drought and the impacts of climate change. However, desalination only accounts for about one percent of the estimated 4,600 km³ of water currently consumed annually around the world. The adoption of desalination infrastructure is currently limited by the cost, energy consumption, greenhouse gas emissions, water inefficiency, and other impacts to the environment and human health caused by desalination systems.

### SUMMARY OF EMBODIMENTS OF THE INVENTION

According to some embodiments of the present inventive concept, a method of selecting a desalination architecture includes a) constructing a desalting subsystem model comprising a superstructure representation configured to evaluate a plurality of desalting subsystems in response to desalting subsystem input parameters; b) constructing an energy subsystem model configured to evaluate a plurality of energy subsystems in response to energy subsystem input parameters; c) selecting an objective function configured to minimize one or more system attributes for a desalination architecture; d) while evaluating one of the plurality of desalting subsystems with the plurality of desalting subsystem input parameters using the desalting subsystem model, determining an optimal one of the plurality of energy subsystems using the energy subsystem model based on the energy requirements of the evaluated one of the plurality of desalting subsystems and the energy subset input parameters; e) evaluating a desalination architecture comprising the evaluated one of the plurality of desalting subsystems and the optimal one of the plurality of energy subsystems; f) if the objective function of the desalination architecture comprising the evaluated one of the plurality of desalting subsystems and the optimal one of the plurality of energy subsystems is not minimized, repeating steps d) and e) with a different one of the plurality of desalting subsystems; and g) when the objective function of the desalination architecture is minimized, selecting the desalination architecture wherein the desalination architecture comprises one of the plurality of desalting subsystems and one of the plurality of energy subsystems. Computer program products and systems are also provided.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a schematic diagram of methods, systems, and computer program products for evaluating a desalting subsystem and determining an optimal energy subsystem according to some embodiments.

FIG. 2 is a schematic diagram of methods, systems, and computer program products for evaluating an energy subsystem model and identifying a solution according to some embodiments.

FIG. 3 is a schematic diagram of methods, systems, and computer program products for optimizing a desalting subsystem according to some embodiments.

FIG. 4 is a schematic diagram of methods, systems, and computer program products for evaluating a desalting subsystem, optimizing a corresponding energy subsystem, and determining a desalination architecture according to some embodiments.

FIGS. 5-7 are schematic diagrams of flowcharts illustrating methods, systems, and computer program products according to some embodiments.

### DETAILED DESCRIPTION OF EMBODIMENTS OF THE INVENTION

Embodiments according to the present inventive concept may help overcome desalination's core barriers to adoption by introducing an original framework for the quantitative performance-based selection of multi-attribute optimal desalination architectures. This framework enables an expansive desalination architecture design space exploration across both desalting and energy subsystems. Desalination architectures are here valuated by mapping their barriers to adoption to their quantifiable performance attributes: cost, GHG emissions, and freshwater recovery.

In some embodiments, a superstructure flowsheet model was constructed in Python to include reverse osmosis (RO), multi-stage flash (MSF), multi-effect distillation (MED), and thermal vapor compression (TVC) desalting technologies. This model was situated inside of an optimization routine and used to explore a new desalting subsystem design space and to identify designs which may outperform those identified in similar efforts.

In order to evaluate complete desalination architectures, an energy subsystem is needed for powering the desalting subsystem. An energy system model was therefore constructed in Python® to include photovoltaic arrays (PV), wind energy converters (WEC), concentrated solar power plants (CSP), battery energy storage, and a connection to a conventional electrical grid and steam generator. Incorporating renewable energy sources enabled the identification of energy subsystems which potentially lowered cost, GHG emissions, and/or water consumption compared to traditional grid and dedicated steam generation systems. An individual desalination architecture alternative is any desalting subsystem alternative connected to an energy subsystem. High speed metamodels were successfully used to represent the full energy system model in order to make desalination architecture evaluation and optimization exercises computationally tenable.

The full desalination architecture evaluation environment including the integrated desalting and energy subsystem models, was situated within an optimization routine. Cost-driven optimization exercises identified renewable energy source driven desalination alternatives which outperformed conventional alternatives identified in similar efforts. In addition, multiple cases were demonstrated wherein the simultaneous consideration of both energy and desalting subsystem performance in desalination architecture optimization exercises identified alternatives which were unidentifiable using the traditional selection approach.

As used herein, “desalination architecture” refers to a system that includes at least a desalting subsystem and an energy subsystem for powering the desalting subsystem.

A valuation structure may be used for evaluating various issues facing desalination systems. Upon establishing an appropriate valuation structure for addressing the issues facing desalination systems, the proposed framework must guide the generation of feasible alternatives. Previous work has considered a large number of alternatives for producing high performing desalting subsystem designs, but the definition of high performing has generally been reserved for systems which excel in terms of low cost. Therefore, the proposed framework is preferably capable of generating high performing designs across each of the attributes of interest: cost, greenhouse gas (GHG) emissions, and concentrate production. Previous work has aimed to generate and explore alternatives within multi-effect distillation (MED), absorption desalination (AD), multi-stage flash (MSF), thermal vapor compression (TVC), and reverse osmosis (RO) systems, strictly thermal systems, or strictly reverse osmosis network (RON) systems. A comprehensive framework for generating full desalting subsystem designs among the most relevant desalination methods to attributes in addition to cost is generally not available.

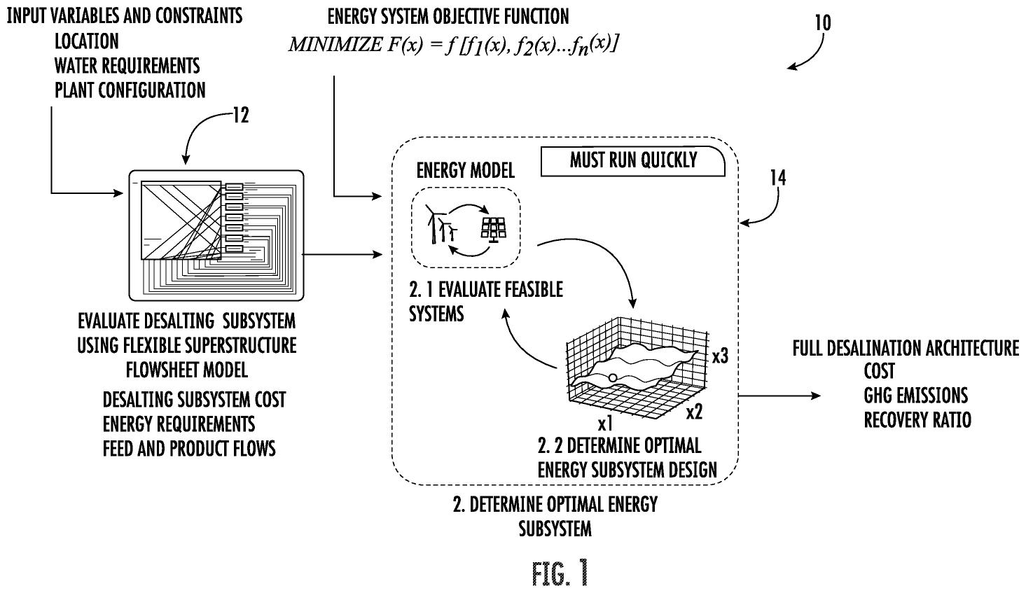

The optimization of full desalination architectures will be described, including desalting and energy subsystems. Decoupling the desalting and energy subsystems of each desalination architecture allows dependency between these to become unidirectional. Therefore, an energy subsystem which is itself optimal with regard to a single desalting subsystem and objective function may be used in conjunction with a selected desalting subsystem to define a single desalination architecture alternative as illustrated in FIG. 1. The subsequent definition of many desalination architectures is evaluated before a single optimal desalination architecture may be identified.

In some embodiments, a method of selecting a desalination architecture includes a) constructing a desalting subsystem model comprising a superstructure representation configured to evaluate a plurality of desalting subsystems in response to desalting subsystem input parameters; b) constructing an energy subsystem model configured to evaluate a plurality of energy subsystems in response to energy subsystem input parameters; c) selecting an objective function configured to minimize one or more system attributes for a desalination architecture; d) while evaluating one of the plurality of desalting subsystems with the plurality of desalting subsystem input parameters using the desalting subsystem model, determining an optimal one of the plurality of energy subsystems using the energy subsystem model based on the energy requirements of the evaluated one of the plurality of desalting subsystems and the energy subset input parameters; e) evaluating a desalination architecture comprising the evaluated one of the plurality of desalting subsystems and the optimal one of the plurality of energy subsystems; f) if the objective function of the desalination architecture comprising the evaluated one of the plurality of desalting subsystems and the optimal one of the plurality of energy subsystems is not minimized, repeating steps d) and e) with a different one of the plurality of desalting subsystems; and g) when the objective function of the desalination architecture is minimized, selecting the desalination architecture wherein the desalination architecture comprises one of the plurality of desalting subsystems and one of the plurality of energy subsystems.

FIG. 1 is a schematic diagram 10 of methods, systems, and computer program products for selecting and evaluating a desalting subsystem and optimizing a corresponding energy subsystem according to some embodiments. A desalting subsystem may first be selected and evaluated at block 12. Input parameters such as the location parameters, water requirements, and the desalting plant configurations may be used as inputs to a flexible superstructure flowsheet model to evaluate the desalting subsystem. The evaluation may be based on desalting subsystem costs, energy requirements, and feed and product flows. The energy flows required to satisfy the requirements of the desalting subsystem may then be passed to the energy subsystem model at block 14. The energy subsystem design space may then be subjected to an optimization exercise capable of producing an optimal collection of energy subsystem design variable settings regarding a set objective function. The result of this process may be a specific desalination architecture whose energy subsystem may be optimal with respect to its desalting subsystem.

As shown in FIG. 1, the energy subsystem model at block 14 identifies the energy subsystem optimization portion of the overall process. As the energy subsystem model design space includes both discrete and continuous variables, a mixed integer non-linear programming (MINLP)-capable optimization scheme may be used. This operation may be evaluated many times and must therefore be computationally efficient and inexpensive. The desalting and energy subsystem optimization operations may be integrated into a single desalination architecture optimization approach. A goal is to efficiently and rapidly evaluate and explore a large relevant design space of renewable energy source subsystems for powering a given desalting subsystem while identifying feasible and multi-attribute optimal configurations.

The optimization of full desalination architectures includes the optimal selection of desalting and energy subsystems. Previous optimization work around desalting subsystems shows this process to be computationally expensive. Therefore, any additions to the complexity of these desalination subsystem models within the subsystem optimizer may contribute additional complexity. Added complexity leads to computational expense when compounded over the many iterations required for an optimization exercise. Therefore, the energy subsystem optimization block 14 in FIG. 1, is configured to add a small amount of computational cost to the overall evaluation environment.

Alternatives for increasing the speed at which the energy optimization block is evaluated include simplifying the energy subsystem model, applying reduced order modeling tactics, loosening the convergence criteria of the incorporated optimizer, or incorporating higher speed optimizers. The energy subsystem model may be simplified to include fewer renewable energy sources or to consider the performance of systems on a larger representative time scale than the typically selected hourly basis used in renewable energy source system design. Reduced order modeling tactics may be introduced to create high-speed mathematical representations of the energy subsystem model. The selection of the optimizer used in the desalination architecture alternative construction process will rely largely on the energy subsystem model design space and what information may be readily available for passage from the energy subsystem model to the optimizer. The convergence criteria for the implemented optimizer will be selected based on its ability to provide promising but not necessarily globally optimal alternatives. As it is of interest to consider the most relevant renewable energy source systems alongside traditional systems at a temporal fidelity that is usual for renewable energy source design, reduced order modeling tactics will be pursued primarily in this work. Although embodiments are described with respect to the optimization block 14, the energy subsystem model and its optimization block 14 may be replaced with similar modules as would be appreciated by one of skill in the art.

Metamodels, often called surrogate models, may be used to simply represent modeling systems. These are used in place of complex computational models such as those used in finite element analysis (FEA) or computational fluid dynamics (CFD) environments. Metamodels allow for the rapid evaluation of complex models, often in exchange for accuracy of the model results. If metamodel accuracy may be reasonably preserved, the speed of these models makes them very useful for use in design space exploration and optimization. For these reasons, the replacement of the energy subsystem model with a metamodel may reduce the computational complexity of the energy subsystem optimization process.

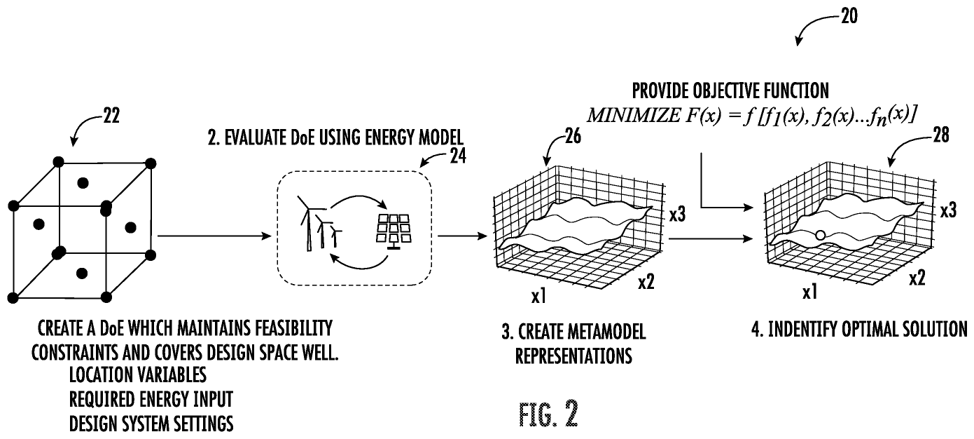

A change to the original desalination architecture evaluation process in FIG. 1 to include the incorporation of a metamodel is shown in FIG. 2, which is a schematic diagram 20 of methods, systems, and computer program products for evaluating an energy subsystem model and identifying a solution according to some embodiments. Here, a metamodel representation of the energy subsystem design space replaces the existing energy subsystem model. The metamodel will be constructed by first strategically sampling the design space through what is called a design of experiments (DOE) at block 22 using the original energy subsystem model and maintains feasibility constraints and covers the design space, including location variables, energy input, and design system settings. The DOE is evaluated using the energy model at block 24. Statistical regression models are constructed to relate the energy system configurations and design variable settings to specific performance attributes for each alternative within the design space. The resulting collection of regression models representing cost, GHG emissions, and water consumption define the metamodel, which is created at block 26. The objective function minimization is performed at block 28.

The construction of the metamodel used to represent the design space of energy subsystem alternatives includes various challenges because the energy system design space maintains a multitude of both configurations and design variable settings governing the components used within these. A metamodel capable of representing this expansive, multi-configuration space may be used. The following example evaluates the efficacy of the proposed energy subsystem optimization block simplification.

Replacing the existing energy subsystem model with a metamodel representation within the desalination architecture evaluation environment may allow for the rapid assembly and evaluation of full desalination architecture alternatives. In addition, this proposed method for identifying optimal energy subsystems, shown in FIG. 2, considers a much greater expanse of the design space compared with prior models.

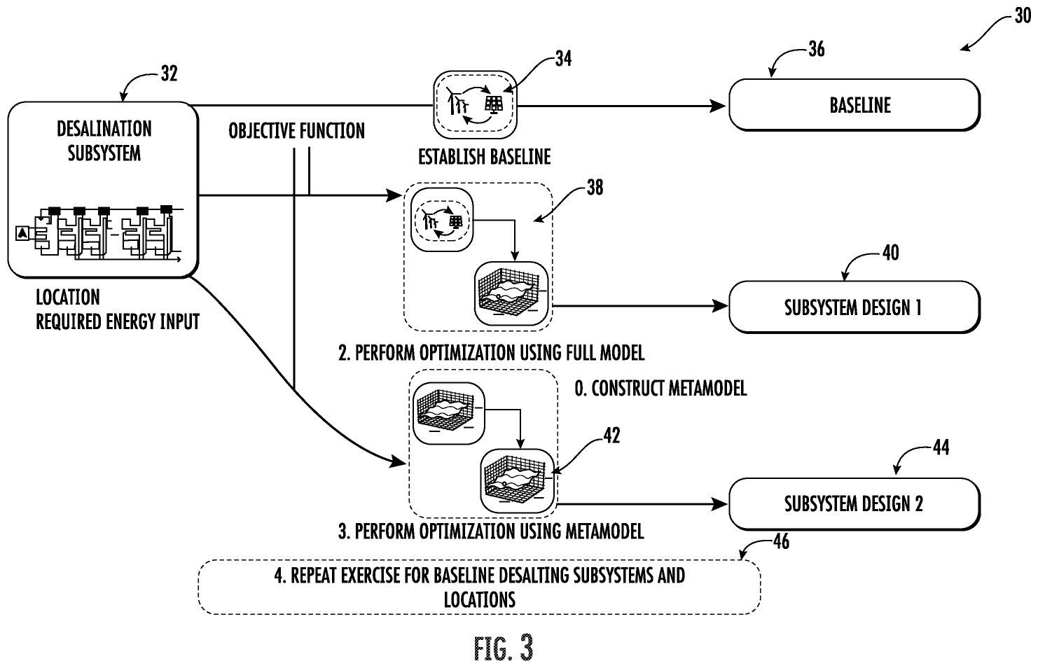

Allowing the energy subsystem optimizer to explore alternatives among such a large and initially undefined collection of configuration alternatives may be used to evaluate optimal desalination architectures. Successful construction of the process shown in FIG. 1 for evaluating desalination architectures with optimal energy subsystems should enable the discovery of new optimal energy subsystems which incorporate previously unconsidered technologies and configurations. An example experiment 30 for a desalting subsystem 32 including a location and required energy input is depicted in FIG. 3 aims to evaluate these suppositions and to investigate the impact of renewable energy source systems on the performance of energy subsystems. It is of interest to quantify the improvements to speed and the impacts to accuracy which may accompany the proposed transition from the energy subsystem model to the metamodel. FIG. 3 describes the following steps:

STEP 0. Construct the metamodel. A DOE for the design space of the intended use of the metamodel will be assembled. This will be populated with an appropriate number of cases to inform the model well, while remaining computationally manageable. Fortunately, the assembly of this metamodel only needs to be performed one time for a given location, making the computational expense of its construction less concerning compared to the computational expense of the full system optimizer. The DOE will be evaluated with respect to each of the attributes of interest, including cost, GHG emissions, and water consumption. The collection of results from the DOE will form the basis of a statistical regression model for each attribute. This collection of mathematical models will define the newly constructed metamodel.

STEP 1. Define the baseline at blocks 34 and 36. Requirements typically passed to the energy subsystem model at block 34 from a desalting subsystem 32 will be selected to represent a baseline case at block 36. This baseline case will be evaluated across each of the three energy subsystem considered attributes using the conventional connection to an electrical grid and dedicated steam generator.

STEP 2. Perform optimization with original model at block 38 to determine subsystem design 1 at block 40. The original process for evaluating a complete desalination architecture, as depicted in FIG. 1, will be implemented and evaluated. This will produce an energy system which is optimal with respect to minimizing cost.

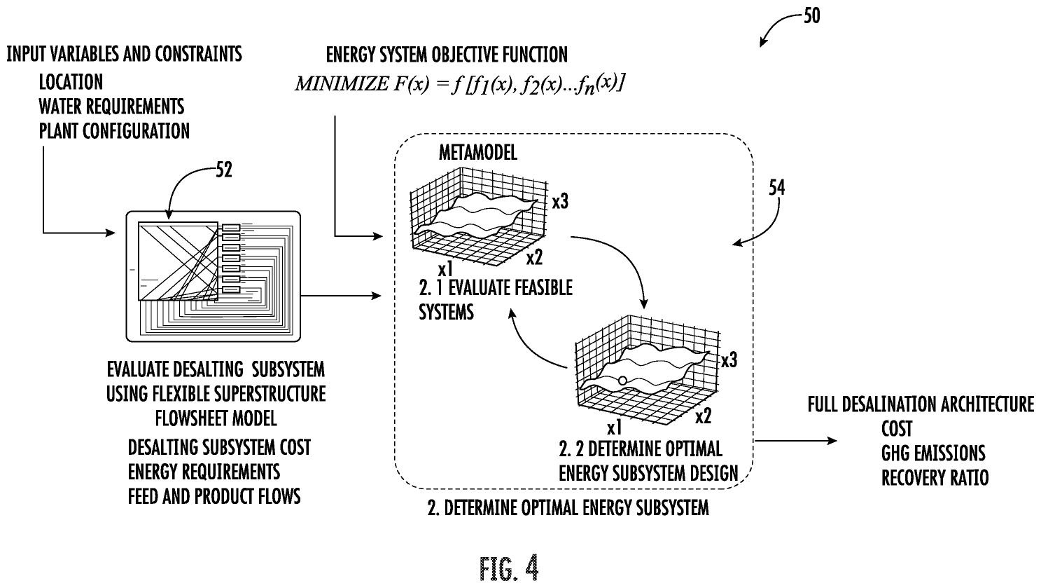

STEP 3. Perform optimization with metamodel at block 42 to determine subsystem design 2 at block 44. The optimization process used in Step 2 will be adapted to replace the energy subsystem model with the constructed metamodel, illustrated in detail in FIG. 4. This will be evaluated to produce an energy subsystem which should be nearly optimal with respect to the objective function used thus far within this experiment. The performance of the optimizer with respect to convergence time, and accuracy of the identified system will be analyzed here.

STEP 4. Perturb the baseline requirement set. Steps 1 through 3 will be repeated at block 46 using requirement sets which vary significantly across the requirement space. For instance, if an electrical power dominant requirement set, representative of an RO desalting unit for instance, is used in the first iteration of Steps 1 through 3, then a thermal power dominant requirement set, representative of an MSF desalting system for instance, will be used for the next iteration, and so on. The metamodel is expected to exhibit different degrees of performance across the design space. In addition to this, a few cases will be introduced to demonstrate circumstances where various renewable energy source technologies may outperform others. Step four is introduced in order to evaluate the impacts of this variability and to demonstrate the use of the energy subsystem model.

The replacement of the complete energy subsystem model with a metamodel is expected to significantly improve the convergence speed of the optimization procedure. However, this increase in speed is expected to come at a cost to the accuracy of the identified optimal solution. The original optimization procedure, performed in Step 2 above, will set the standard by which the accuracy of the metamodel optimization of the Step 3 will be compared. It is expected that the metamodel based optimization process will identify optimal energy solutions which are nearly identical to the original optimal solutions, but in significantly less time. It is also expected that the energy subsystems identified through the optimization exercises in Steps 0-4 will outperform conventional systems, by incorporating renewable energy source systems. The energy subsystem evaluation process performed herein in Steps 0-4, through its full energy subsystem model evaluation closing each optimization exercise, shares equivalency with “best practices” in the conceptual design of renewable energy generation systems.

Steps 0-4 may produce a metamodel which is appropriate for rapid evaluation toward the identification of an energy subsystem optimum. Considering this, FIG. 4 illustrates the proposed process for evaluating complete desalination architectures. Any desalination architecture evaluated using the proposed process includes a desalting subsystem which may or may not be optimal, powered by an optimal energy subsystem regarding a given objective function and set of requirements.

FIG. 4 is a schematic diagram 50 of methods, systems, and computer program products for evaluating a desalting subsystem, optimizing a corresponding energy subsystem, and determining a desalination architecture according to some embodiments. As illustrated in FIG. 4, input parameters, such as the location, water requirements, and plant configurations of a desalting subsystem may be evaluated using a flexible superstructure model at block 52. The superstructure model may evaluate the desalting subsystem based on functions such as costs, energy requirements, and feed and product (water flows). The evaluated desalting subsystem and an energy system objective function may be used as inputs to block 54 to determine an optimal energy subsystem by evaluating feasible energy systems with a metamodel and determining optimal energy subsystem designs. A full desalination architecture, including desalting subsystem and energy subsystem, may be determined, for example, based on an objective function that considers cost, greenhouse gas emissions, and a recovery ratio.

The consideration of dependency between the desalting and energy subsystems to be unidirectional impacts the generation of single desalination architecture alternatives. This does not however obscure the impact of the simultaneous consideration of both desalting and energy subsystems in the desalination architecture design space exploration, optimal alternative identification, or selection. Traditional methods consider desalting and energy subsystems independently. An optimum is found regarding the desalting subsystem, and then a second optimization exercise is performed to find the optimal energy subsystem for powering the desalting subsystem, This approach may limit the full extent of the integrated design space, as both desalination and energy systems contribute interdependently to the same overall system attributes of performance. This is especially true with the growing adoption of renewable energy source systems for providing electrical, thermal, and mechanical energy. For example, if a desalination system is selected independently of its energy system, then a reverse osmosis (RO) type device may be the result. Then, when selecting the optimal energy system for powering this, perhaps a wind and photovoltaic (PV) based system will be chosen. This approach has produced an RO system powered by wind and PV energy generators as the optimal system. Alternatively, if the desalination plant is to service a location with a high level of solar irradiance, a totally different system, perhaps a multi-stage flash (MSF) plant powered by concentrated solar power (CSP) may be an even better choice. However, consideration of MSF as the desalination technology has been ruled out earlier in the exercise since its performance independent of available energy makes it less attractive. Including the consideration of desalination architectures as their integrated whole including both desalting and energy subsystems together may result in better overall architecture selection. Accordingly, it is posited that if desalination plant designers search for complete architectures with integrated desalting and energy subsystems, then traditional desalination plant design will be improved through the identification of cheaper, cleaner, and more water efficient architectures.

A large amount of the previous research has considered different configurations and design variable settings across complete desalination architectures. Some embodiments may address considering the integration of desalting and energy subsystems within desalination architectures.

In order to explore the entire relevant design space of complete desalination architectures, the capability of optimizing a single desalination architecture based on its requirements may first be developed. The desalination architecture evaluation process depicted in FIG. 4 integrates a single desalination subsystem with an optimal energy subsystem regarding a given requirement set and objective function. This has been constructed as a unidirectional decoupled system to allow for independence between the energy and desalination subsystem analyses. This process may identify optimal complete desalination architectures regarding a given objective function and set of requirements.

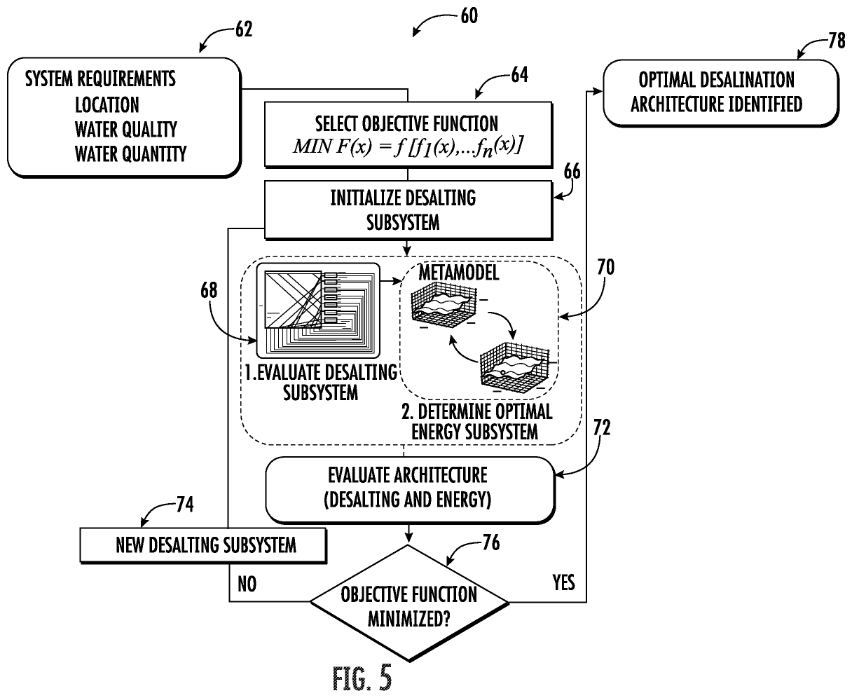

FIG. 5 is a flowchart 60 illustrating methods, systems, and computer program products according to some embodiments. The flowchart 60 of FIG. 5 illustrates the proposed process for identifying optimal complete desalination architectures with regard to a single objective function. Here, the system requirements including the location of the plant, the amount of water required to be produced, and the starting and finishing water conditions are established and passed to the optimization environment at block 62. A single objective function is set at block 64 to minimize cost with constraints placed to minimize greenhouse gas emissions and bound water recovery are established and passed to the optimization environment. The optimization environment is initialized at block 66 by selecting a starting desalting subsystem design. The desalting subsystem is evaluated at block 68 and is matched with an associated optimal energy subsystem in-line with the overall desalination architecture objective function at block 70, forming a full desalination architecture, as shown in FIG. 4. This complete architecture is then evaluated at block 72. If the objective function is not minimized at block 76, another desalting subsystem is selected at block 74, and this process is repeated many times until an optimal complete desalination architecture is identified at block 78. The specific changes made to the desalting subsystem depend upon the optimization method pursued. Each iteration produces a new desalting subsystem design, which is then matched to an optimal energy subsystem, forming a complete desalination architecture alternative. After multiple iterations, an optimal complete desalination architecture is produced.

In this configuration, an appropriate parameter space for the superstructure flowsheet desalting subsystem model may be established, and an energy subsystem is selected to reduce the computational expense of determining an optimal desalination architecture, including both a desalting subsystem and an energy subsystem.

Accordingly, inclusion of competitive renewable energy source systems in the design of desalination architectures may improve the performance of these systems. In addition, searching for multi-attribute optimal desalination architectures which consider desalting and energy subsystems together can produce alternatives which perform equally or better than those identified using the traditional desalination design es.

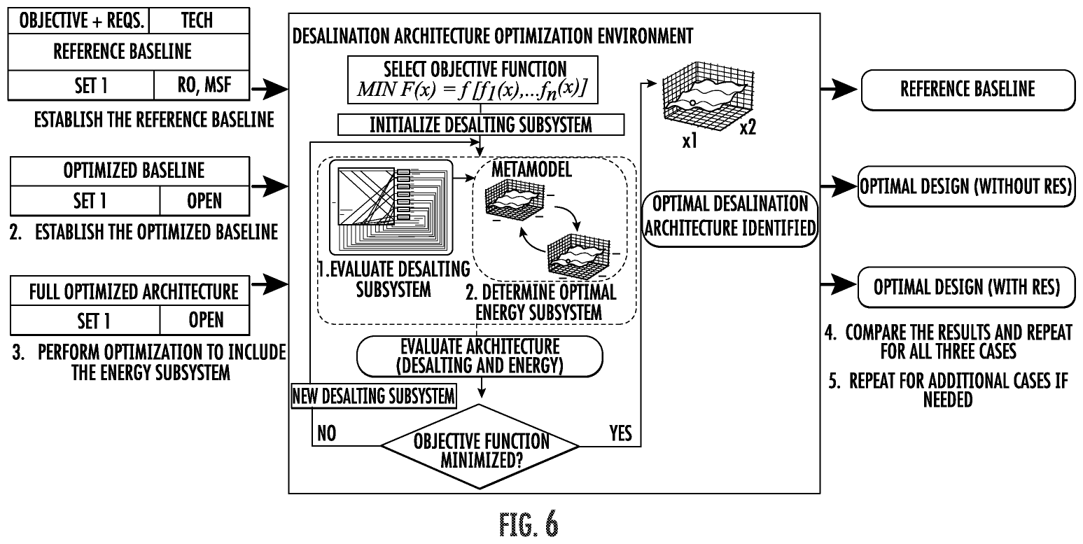

The improvement to desalination architecture performance as well as the impacts to solution time associated with identifying competitive solutions which are integrated with optimized energy subsystems may be quantified as illustrated in FIG. 6, which compares the results of an optimal design without renewable energy sources (RES) and with renewable energy sources (RES), including the following steps:

STEP 0. Assemble the full desalination architecture evaluation and optimization environment. The extended superstructure flowsheet model used for evaluating desalination subsystems will be coupled with the metamodel-based energy subsystem optimization environment, in a structure reflecting that of FIG. 4.

STEP 1. Re-establish the baseline. The constructed superstructure flowsheet model will be used to evaluate each of the identified optimal alternatives within the three case studies presented by Skiborowski, Mirko, et al. “Model-based structural optimization of seawater desalination plants.” Desalination 292 (2012):30-44. (“Skiborowski”). Grid electricity and dedicated steam generation is considered. This case serves as the desalting subsystem reference baseline.

STEP 2. Identify cost optimal alternatives. The superstructure flowsheet model will be evaluated using the same objective function and requirement sets used by Skiborowski across each of the three cases. However, the complete superstructure flowsheet model will be opened, allowing for a significantly larger design space exploration. The time required to perform this optimization will be recorded. The reduced superstructure alternative described above may be used as the desalting subsystem optimized baseline here.

STEP 3. Introduce energy subsystem optimization. The optimization exercise performed in step two will be repeated using the energy subsystem optimization as described herein. This will allow for a comparison between the optima determined with and without the energy subsystem optimization and the time required to accomplish these design space explorations. In some embodiments, a parameter reduced model space may be used, for example, based on a subset of parameters that have a greater weight to the design. The minimization of cost may be set as the objective function.

STEP 4. Compare the results. It is expected that the optimal desalination architecture identified in step two and step three will vary significantly from the baseline system in both configuration, design variable settings, and estimated performance. It is expected that the optimal desalting system identified in step three will significantly outperform that identified in step two but at significant cost to optimization time.

STEP 5. If the three cases explored above do not offer useful information toward the validation of the hypothesis to determine if traditional desalination plant designs may be improved through the identification of cheaper, cleaner, and more water efficient architectures, additional cases will be explored.

The above steps and their equivalency with actual desalination systems is dependent upon the accuracy of its models in representing their respective system's physics. Validation may be performed to substantiate the use of each model. In addition, this work's product framework is flexible enough to replace its constituent models with preferred models of future users. Including renewable energy source systems into the desalination architecture evaluation environment is expected to improve the performance of alternatives across the attributes considered. Consideration of both desalting and energy subsystems in the exploration of desalination architectures is expected to lead to the identification of optimal desalination architectures which were previously undetectable as such.

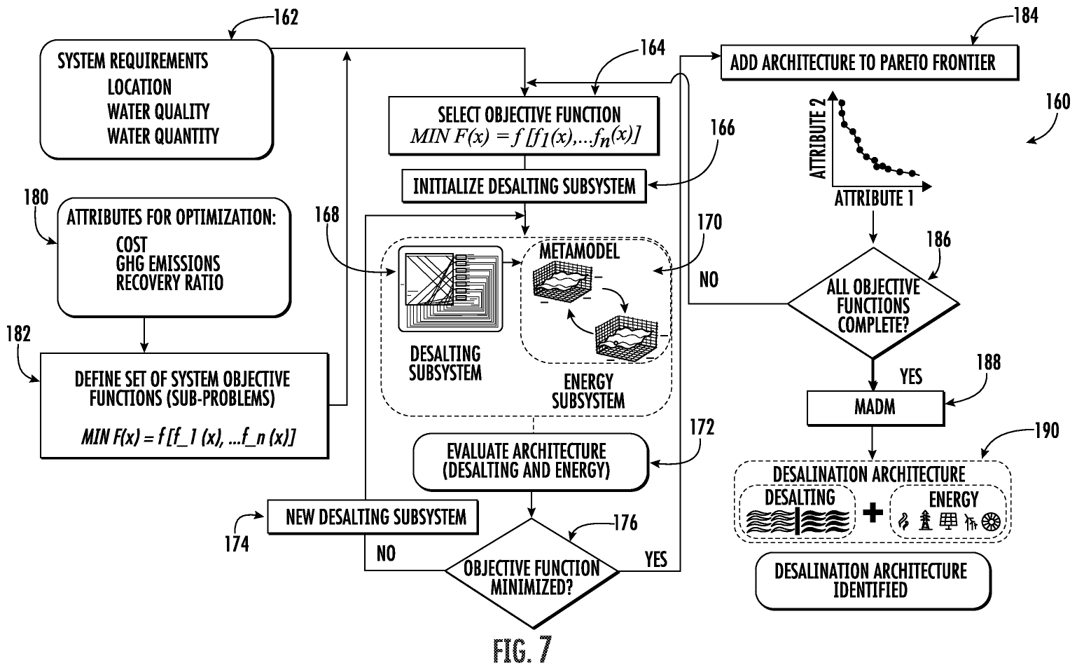

The final assembly of the proposed desalination architecture selection framework may be guided by the various elements developed and exercised throughout the conducted experiments and computations. The design space exploration and identification of promising desalting subsystem designs is performed using a superstructure flowsheet model which considers together each of the most relevant desalting technologies. The desalting subsystem model design space may be reduced. From here, the design space exploration and identification of promising desalination architecture designs is performed using an integrated energy and desalting subsystem analysis capability, as is shown in FIG. 5. The computational burden of the energy subsystem model applied here is extraordinarily reduced using high-speed metamodels. Finally, the multi-objective optimization approach is used to first populate the multi-attribute non-dominated design space boundary, or Pareto frontier, and to identify from this a multi-attribute optimal desalination architecture. FIG. 7 shows this complete framework in which a set of system objective problems are used in multi-attribute decision making (MADM). In FIG. 7, blocks 160-178 correspond generally to blocks 60-78 of FIG. 5. In addition, attributes for optimization, including cost, greenhouse gas emissions, and recovery ratios in Block 180 may be used to define a set of objective functions at Block 182. When a function is minimized at block 176, the architecture may be added to a Pareto Frontier at Block 184. If all objective functions are complete at block 186, then multi-attribute decision making (MADM) is used at block 188 to identify a desalination architecture at block 190.

Accordingly, some embodiments of the present inventive concept may decrease the computational requirements to optimize desalination architecture design for a particular location, for example, by determining which factors contribute a more significant amount to the objective function(s) and/or by using objective functions that include both desalting subsystems and energy subsystems. Therefore, the objective functions of the energy subsystem and the desalting subsystem may be simultaneously evaluated for designing and building new desalination architecture for a particular location and/or specific system inputs and outputs.

The present inventive concepts are described herein with reference to the accompanying drawings and examples, in which embodiments are shown. Additional embodiments may take on many different forms and should not be construed as limited to the embodiments set forth herein. Rather, these embodiments are provided so that this disclosure will be thorough and complete, and will fully convey the scope of the inventive concepts to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting thereof. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

The present invention is described herein with reference to operations that can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts described herein.

These computer program instructions may also be stored in a computer-readable memory that can direct a computer or other programmable data processing apparatus to function in a particular manner, such that the instructions stored in the computer-readable memory produce an article of manufacture including instructions which implement the function/act described herein.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts described herein.

Accordingly, the present invention may be embodied in hardware and/or in software (including firmware, resident software, micro-code, etc.). Furthermore, embodiments of the present invention may take the form of a computer program product on a computer-usable or computer-readable non-transient storage medium having computer-usable or computer-readable program code embodied in the medium for use by or in connection with an instruction execution system.

The foregoing is illustrative of the present inventive concept and is not to be construed as limiting thereof. Although a few example embodiments have been described, those skilled in the art will readily appreciate that many modifications are possible in the exemplary embodiments without materially departing from the novel teachings of this inventive concept. Accordingly, all such modifications are intended to be included within the scope of this inventive concept as defined in the claims. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims.

What is claimed is:

1. A method of selecting a desalination architecture, the method comprising:
a) constructing a desalting subsystem model comprising a superstructure representation configured to evaluate a plurality of desalting subsystems in response to desalting subsystem input parameters;
b) constructing an energy subsystem model configured to evaluate a plurality of energy subsystems in response to energy subsystem input parameters;
c) selecting an objective function configured to minimize one or more system attributes for a desalination architecture;
d) while evaluating one of the plurality of desalting subsystems with the plurality of desalting subsystem input parameters using the desalting subsystem model, determining an optimal one of the plurality of energy subsystems using the energy subsystem model based on the energy requirements of the evaluated one of the plurality of desalting subsystems and the energy subset input parameters;
e) evaluating a desalination architecture comprising the evaluated one of the plurality of desalting subsystems and the optimal one of the plurality of energy subsystems;
f) if the objective function of the desalination architecture comprising the evaluated one of the plurality of desalting subsystems and the optimal one of the plurality of energy subsystems is not minimized, repeating steps d) and e) with a different one of the plurality of desalting subsystems; and
g) when the objective function of the desalination architecture is minimized, selecting the desalination architecture wherein the desalination architecture comprises one of the plurality of desalting subsystems and one of the plurality of energy subsystems.

2. The method of claim 1, wherein plurality of desalting subsystems are selected from the group consisting of reverse osmosis desalting systems, multi-effective distillation desalting systems, thermal vapor compression desalting systems, and multi-stage flash desalting systems.

3. The method of claim 2, wherein the plurality of desalting subsystem input parameters comprises an operating environment for each of the plurality of desalting subsystem.

4. The method of claim 1, wherein the plurality of energy subsystems are selected from the group consisting of photovoltaic cells, wind energy convertors, concentrated solar power, battery storage, and grid electricity.

5. The method of claim 4, wherein the objective function is configured to at least reduce a cost parameter, to reduce a greenhouse gas emissions parameter, or to increase a water recovery parameter.

6. The method of claim 1, further comprising identifying a subset of the plurality of desalting subsystem input parameters and the plurality of energy subsystem input parameters that contribute a greater amount to the objective function, and in step d) evaluating one of the plurality of desalting subsystems with subset of the plurality of desalting subsystem input parameters and determining an optimal one of the plurality of energy subsystems using the energy subsystem model based on the energy requirements of the evaluated one of the plurality of desalting subsystems.

7. The method of claim 1, wherein the desalination architecture selected in step g) comprises one or more of a location, a desalting subsystem, and an energy subsystem.

8. The method of claim 1, wherein the plurality of energy subsystems comprise renewable energy sources.

9. The method of claim 1, wherein the objective function comprises a plurality of objective functions.

10. The method of claim 1, further comprising generating plans for building the desalination architecture and/or building the desalination architecture.

11. A computer program product for selecting a desalination architecture, the computer program product comprising: a non-transient computer readable medium having computer readable program code embodied therein, the computer readable program code comprising:
a) computer readable program code configured to construct a desalting subsystem model comprising a superstructure representation configured to evaluate a plurality of desalting subsystems in response to desalting subsystem input parameters;
b) computer readable program code configured to evaluate a plurality of energy subsystems in response to energy subsystem input parameters;
c) computer readable program code configured to select an objective function configured to minimize one or more system attributes for a desalination architecture;
d) computer readable program code configured to, while evaluating one of the plurality of desalting subsystems with the plurality of desalting subsystem input parameters using the desalting subsystem model, determine an optimal one of the plurality of energy subsystems using the energy subsystem model based on the energy requirements of the evaluated one of the plurality of desalting subsystems and the energy subset input parameters;
e) computer readable program code configured to evaluate a desalination architecture comprising the evaluated one of the plurality of desalting subsystems and the optimal one of the plurality of energy subsystems; and
f) computer readable program code configured to, if the objective function of the desalination architecture comprising the evaluated one of the plurality of desalting subsystems and the optimal one of the plurality of energy subsystems is not minimized, repeat steps d) and e) with a different one of the plurality of desalting subsystems;
g) computer readable program code configured to, when the objective function of the desalination architecture is minimized, select the desalination architecture wherein the desalination architecture comprises one of the plurality of desalting subsystems and one of the plurality of energy subsystems.

12. The computer program product of claim 11, wherein plurality of desalting subsystems are selected from the group consisting of reverse osmosis desalting systems, multi-effective distillation desalting systems, thermal vapor compression desalting systems, and multi-stage flash desalting systems.

13. The computer program product of claim 12, wherein the plurality of desalting subsystem input parameters comprises an operating environment for each of the plurality of desalting subsystem.

14. The computer program product of claim 11, wherein the plurality of energy subsystems are selected from the group consisting of photovoltaic cells, wind energy convertors, concentrated solar power, battery storage, and grid electricity.

15. The computer program product of claim 14, wherein the objective function is configured to at least reduce a cost parameter, to reduce a greenhouse gas emissions parameter, or to increase a water recovery parameter.

16. The computer program product of claim 11, further comprising computer program code configured to identify a subset of the plurality of desalting subsystem input parameters and the plurality of energy subsystem input parameters that contribute a greater amount to the objective function, and in step d) to evaluate one of the plurality of desalting subsystems with subset of the plurality of desalting subsystem input parameters and determining an optimal one of the plurality of energy subsystems using the energy subsystem model based on the energy requirements of the evaluated one of the plurality of desalting subsystems.

17. The computer program product of claim 11, wherein the desalination architecture selected in step g) comprises one or more of a location, a desalting subsystem, and an energy subsystem.

18. The computer program product of claim 11, wherein the plurality of energy subsystems comprise renewable energy sources.

19. The computer program product of claim 11, wherein the objective function comprises a plurality of objective functions.

20. The computer program product of claim 11, further comprising computer program code configured to plans for building the desalination architecture.
